(19) United States
(12) Patent Application Publication
(10) Pub. No.: US 2023/0090505 A1
(43) Pub. Date: Mar. 23, 2023

(54) METHOD AND SYSTEM FOR GENERATING REAL ESTATE APPRAISALS

(71) Applicant: REAL - REAL ESTATE APPRAISAL LOGISTICS INC., Toronto (CA)

(72) Inventors: Kevin REID, Toronto (CA); David GASTEIGER, Toronto (CA)

(21) Appl. No.: 17/798,186

(22) PCT Filed: Feb. 10, 2021
(86) PCT No.: PCT/CA2021/050146

§ 371 Date: Aug. 8, 2022

Related U.S. Application Data
(60) Provisional application No. 62/972,169, filed on Feb. 10, 2020.

(51) Int. Cl. G06Q 30/02; G06Q 50/16

(52) U.S. Cl. CPC G06Q 30/0278; G06Q 50/16; G06Q 30/0206

(57) ABSTRACT

A system and method for generating a real estate appraisal. Characteristics of a property of interest are compared with the characteristics of different real estate properties to determine a set of comparable real estate properties. The sales prices associated with the set of comparable real estate properties are then adjusted based on predetermined criteria and a final valuation of the property of interest is generated based on these adjusted sales prices.

### CROSS-REFERENCE TO OTHER APPLICATIONS

The current disclosure claims priority from U.S. Provisional Application No. 62/972,169 filed Feb. 10, 2020 which is hereby incorporated by reference.

### FIELD

The disclosure is generally directed at real estate and, more specifically, at a method and system for generating real estate appraisals.

### BACKGROUND

Residential real estate appraisals are an integral part of our financial industry. Mortgage lenders/brokers, real estate agents and the general public rely on a valuation of residential real estate that is fair, transparent, and consistent. Inevitably, there are conflicting positions within the industry. Mortgage lenders rely on valuations for mortgages and home equity lines of credit (HELOCs) for a major portion of their business. Although they would profit from higher valuations for mortgages and HELOCs, they also need valuations that allow for security should a homeowner default. Real estate agents work on a percentage of sale basis, with higher valuations that generate higher commissions. Homeowners benefit from higher sales price of their home when they sell and a lower sales price when they buy. One of the major residential property owner complaints is that two separate real estate appraisals occurring at the same time can yield two differing valuations.

Therefore, there is provided a novel method and system for generating real estate appraisals.

### SUMMARY

The disclosure is directed at a method and system for real estate appraisals. In one embodiment, a user (or appraiser) enters inputs (or characteristics) for a property of interest, or a property they wish to appraise (also known as the subject property). These inputs may include negotiable and non-negotiable characteristics that are to be used in the real estate appraisal. The characteristics include, but are not limited to, municipality, location, property type, building type, design style, bedrooms, full bath, half bath, basement and/or parking. The system then takes the inputs and compares them with the characteristics of other real estate properties and then and generates a predetermined number, such as five, comparable real estate properties. In one embodiment, this may be based on the lowest gross percent difference between the property of interest and the comparable real estate properties. The user may then select a subset of the comparable real estate properties, such as three comparables, based on local market knowledge and comparing/assessing the interior and exterior condition of the properties, such as poor, fair, average, good or excellent, of the property of interest and the original, pre-determined list. The system then calculates gross and net adjustments of the selected comparable real estate properties. A report may then be generated for the user in accordance with the expected standards.

In another embodiment, the system is stored in the form of computer readable medium that includes computer executable instructions to execute the method of the disclosure. In another embodiment, the system of the disclosure provides an auto-assisted valuation model/system that saves time and provides reliable valuations.

### DESCRIPTION OF THE DRAWINGS

Embodiments of the present disclosure will now be described, by way of example only, with reference to the attached Figures.

FIG. 1 is a schematic diagram of a system for generating real estate appraisals in its environment;

FIG. 2 is a schematic diagram of the system for real estate appraisal;

FIG. 3 is a flowchart outlining a method of real-estate appraisal;

FIG. 4 is a flowchart outlining a method of generating a comparable sales output;

FIG. 5 is a flowchart outlining a method of generating a comparable sales report;

FIG. 6 is a flowchart outlining a method of setting driver values;

FIG. 7 is a flowchart outlining a method of adjustment/reconciliation;

FIG. 8 is a chart showing regression analysis;

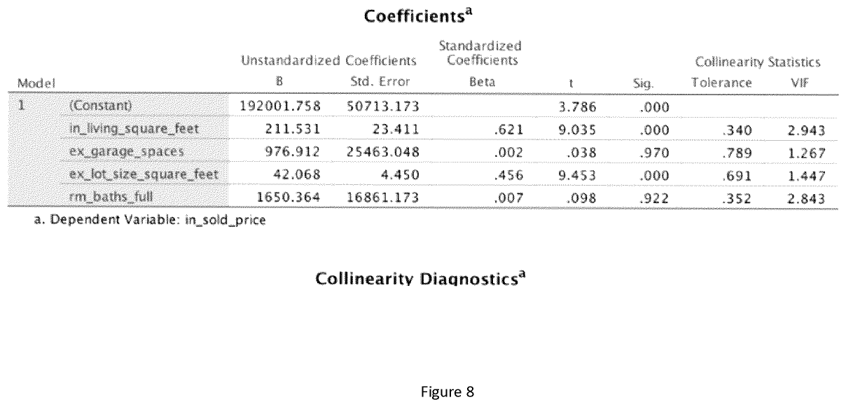

FIG. 9 is a flowchart outlining another embodiment of a method of real estate appraisal;

FIG. 10 is a flowchart outlining a further embodiment of a method of real estate appraisal; and

FIG. 11 is a flowchart outlining another embodiment of a method of real estate appraisal.

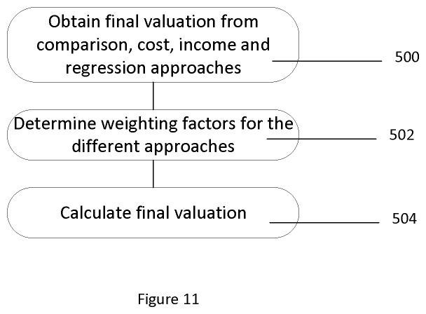

### DETAILED DESCRIPTION OF THE EMBODIMENTS

The disclosure is directed at a system and method for generating real estate appraisals. In one embodiment, the system compares different characteristics between a property of interest with real estate properties to generate a list of comparable real estate properties. The system may then generate a valuation based on sale prices, and the like, of some of the list of comparable real estate properties. The valuation may include applying adjustments to the sale prices of the comparable real estate properties to account for different factors.

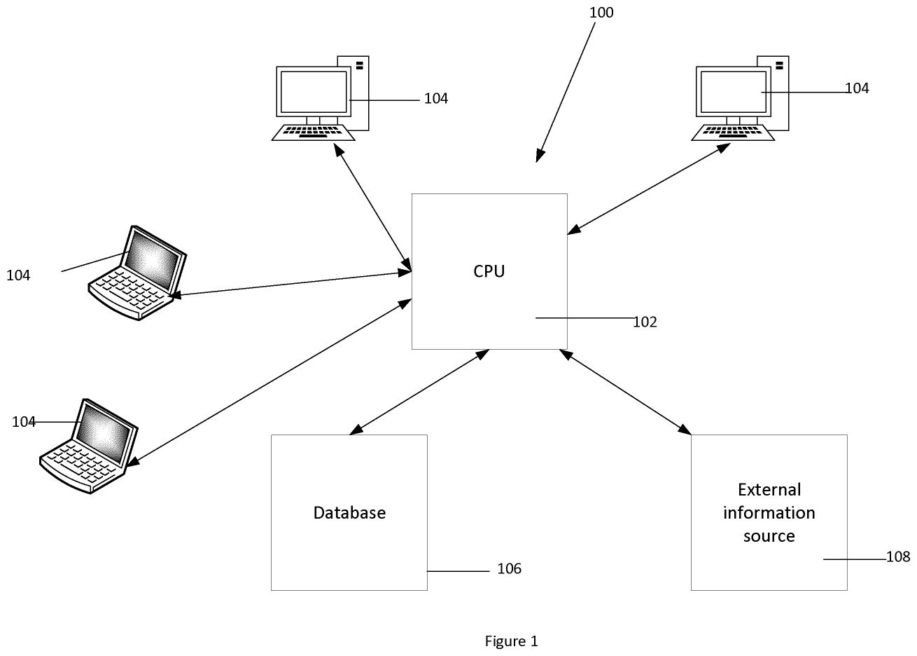

Turning to FIG. 1, a system for real estate appraisal is shown. In the current embodiment, the system 100 includes a central processing unit (CPU) 102 such as, but not limited to a server, that communicates with user devices 104, such as, but not limited to, a laptop, a desktop computer, a Smartphone™ and the like. The system 100 may further include a database 106 for storing the appraisals or for storing information associated with other real estate properties. In some embodiments, a single database may store this information, however, in other embodiments, they may be stored in multiple databases. The CPU 102 may also communicate with at least one external information source 108 to retrieve information.

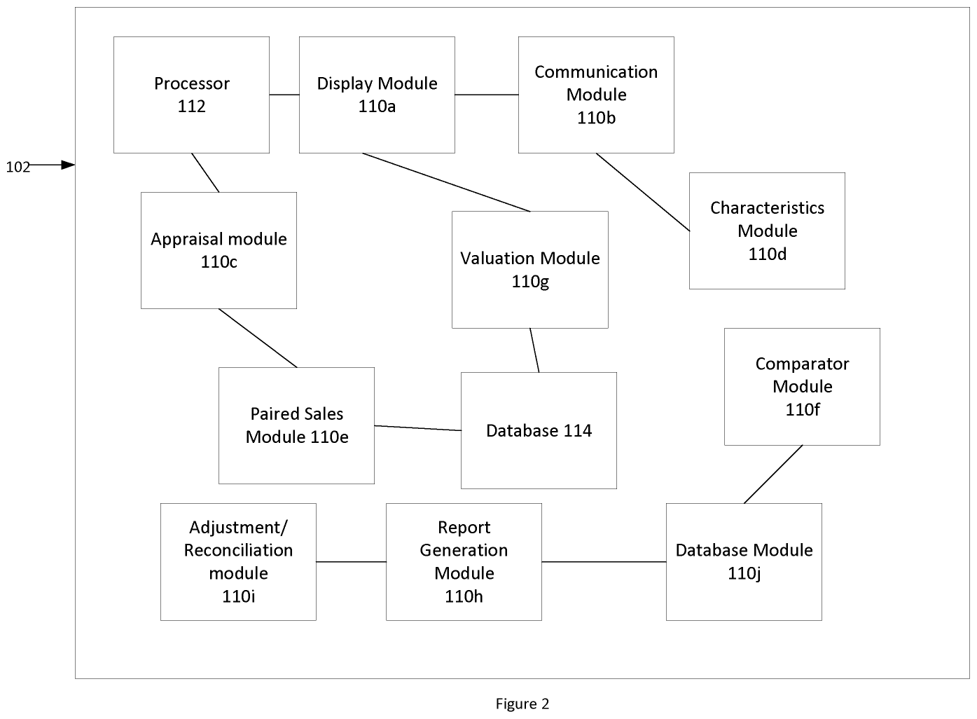

Turning to FIG. 2, a schematic diagram of the CPU 102 is shown. In one embodiment, the CPU 102 includes a set of modules 110 that include computer readable code that, if executed, perform functionality to enable a method of real estate appraisal. The set of modules 110 may include a display module 110a, a communication module 110b, an appraisal module 110c, a characteristics module 110d, a paired sales module 110e, a comparator, or comparable sales, module 110f, a valuation module 110g, a report generation module 110h, an adjustment/reconciliation module 110i and a database module 110j. The CPU 102 also includes a processor 112 and a database 114. Although only certain connections between the modules 110, the processor 112 and the database 114 are shown, it will be understood that other connections are contemplated but not shown in the Figure for matters of clarity.

The display module 110a may provide the functionality of generating the screens or displays that are shown to the user, such as in the form of reports or information about real estate properties. The communication module 110b provides the functionality of enabling communication between the system and the user devices 104, the database 106 and/or the external information sources 108. Communication between the system and these components will be understood. The system may further include a database module 110j that provides the functionality of translating or re-coding information received from external information sources so that the information may be compatible for use with the system. The database module 110j may be implemented in the form of an application programming interface (API). The appraisal module 110c may provide the functionality of generating the real estate appraisal. The appraisal module 110c may communicate with the other modules 110 and the processor 112 to generate the real estate appraisal, as will be described in more detail below. The characteristics module 110d may store different characteristics relating to real estate properties and may also store the different negotiable and non-negotiable characteristics. The paired sales module 110e may provide the functionality of comparing characteristics of real estate properties and generating pairs based on similar or identical shared characteristics to generate accurate adjustment values. The comparator module 110f provides the functionality of comparing the characteristics of a property of interest with characteristics of other real estate properties to determine a set of comparable real estate properties so that the appraisal module may be able to generate a real estate appraisal. The adjustment/reconciliation module 110i may generate a report to the user based on comparable properties chosen by the user. The valuation module 110g may generate a value of the property of interest or may generate a value of one of the real estate properties if certain criteria are met. For instance, the value may be generated based on or more value determination approaches, such as discussed below. The report generation module 110h generates reports or lists that may then be displayed to and reviewed by the user. Examples of reports may include, but are not limited to, a comparable sales report or an adjustment/reconcile report. In one embodiment, the report generation module 100h transmits the information to the displayed to the display module 110a which then may generate a display of the information which is then transmitted to a user device by the communication module 110b.

It is understood that any of the modules may be combined with other modules to form a single module that provides multiple functionality. Alternatively, some of the functionality of one module may be also performed by another module.

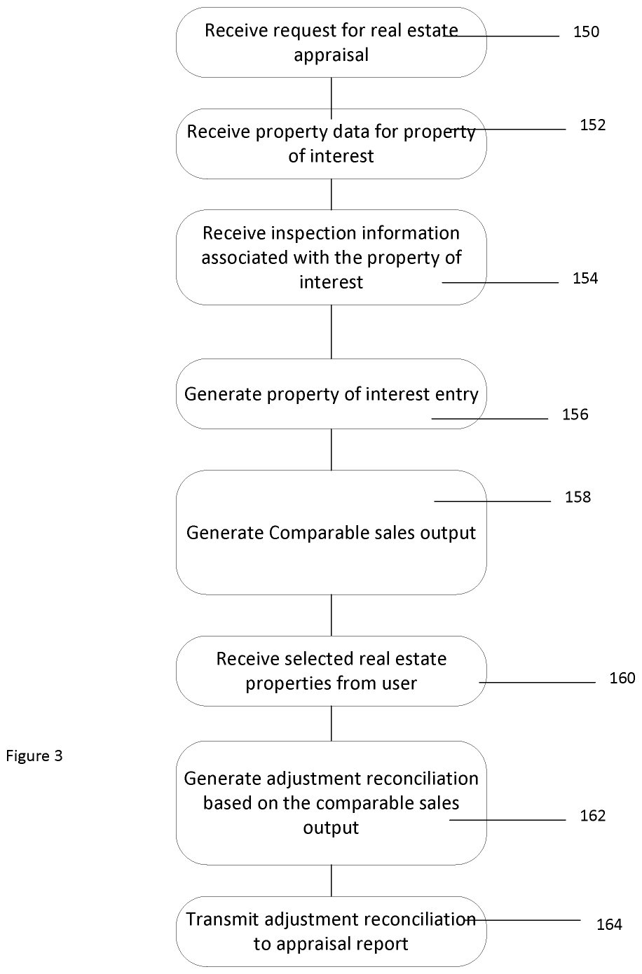

Turning to FIG. 3, a flowchart outlining a method of real-estate appraisal is shown. Initially, a request for a real estate appraisal is received (150). In one embodiment, a user (which may be seen as an appraiser), via their user device, may access the CPU to request a real estate appraisal to be performed. After receiving the request, a set of predetermined property data associated with the property of interest, or subject property, is received (152). In one embodiment, to initiate the method of real estate appraisal of the subject property, the user enters at least some of the predetermined property data associated with the property of interest into the system. This predetermined property data may include characteristics such as, but not limited to, address, year the house was built, previous sales and the like. In some embodiments, the system may receive all of the predetermined property data for identifying the property of interest from the user. In other embodiments, the system may populate the property data fields after receiving the predetermined property data from the user by retrieving the property data or information from a predetermined data set or a real estate database.

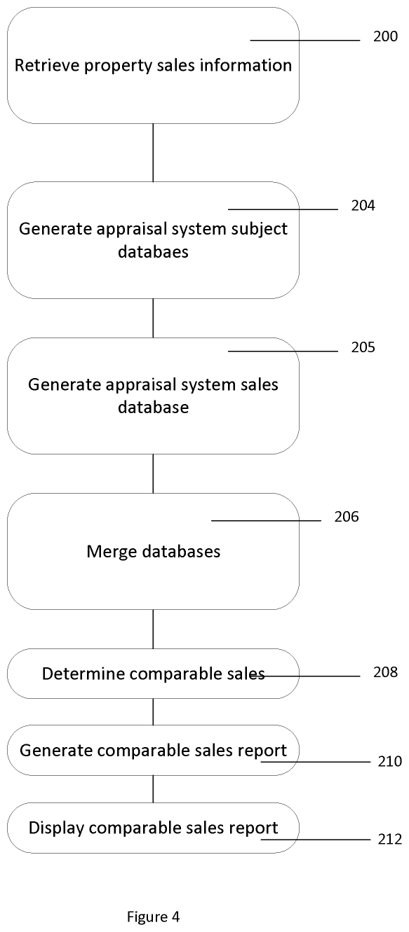

The system may then receive inspection information associated with the property of interest (154). The inspection information may include, but is not limited to site, neighbourhood and/or improvement input data that is either inputted by the user or retrieved from an external source. The inspection information may also include an overall assessment of the interior and exterior condition (poor, fair, good, average, excellent) of the property of interest and assigned by the user. This information may then be used to generate a property of interest entry (156). The system may then provide a comparable sales output (158) for the property of interest. It will be understood that receipt of the property data (152), the inspection information (154) and the generation of the comparable sales output (158) may be performed concurrently or in any order. The comparable sales output may be in the form of a sales report or a list of comparable real estate properties that have characteristics matching the characteristics of the property of interest. One embodiment of providing a comparable sales output is shown in FIG. 4.

As schematically shown in FIG. 4, the system receives or retrieves sales information associated with real estate properties (200) which may involve, but is not limited to, the continual data mining of current and historical sales of local real estate (or real estate property information proximate the property of interest) for example, via an API. In some embodiments, sales information associated with the property of interest may be retrieved due to previous listing activity. In one embodiment, the information that is retrieved or received may be verified by a user to confirm that the information is up to date.

The set of predetermined property data and, if available, the inspection report data, may then be recoded, stored or used to generate an appraisal system subject database or property of interest database (204). This database may include the property of interest entry. Different characteristics of the property of interest may be stored in the appraisal system subject database. These characteristics may include negotiable characteristics and non-negotiable characteristics for determining comparable real estate property sales. Examples of non-negotiable characteristics or non-negotiables may include, but are not limited to, Municipality—References a region (e.g. City of Waterloo); Map location—References a location within a municipality; Property Type—1 sold; 2 sold pending; Building Type—Denotes townhouse, semi-detached, detached, condo; and/or Design Style—Bungalow, Two Storey, etc. Examples of negotiable characteristics or negotiables include, but are not limited to, Bedrooms—References the number of bedrooms; Full Bath—References the number of bathrooms with 3/4pc (toilet, sink, and shower/bath); Half Bath—References the number of bathrooms with 2 pc (toilet and sink only); Basement—Denotes whether a basement is finished, unfinished or partially finished; and/or Parking—Denotes the type of parking (e.g. single attached, double detached).

The system may also generate an appraisal system sales database (205) that may include data associated with the non-negotiable and negotiable characteristics of different real estate properties which may be used for comparison between the property of interest and the other real estate properties. The appraisal system sales database may be generated from the information retrieved or received in (200). In one embodiment, the appraisal system sales database may be generated with all real estate properties that have been recently sold or are currently being listed. In another embodiment, the scope of the appraisal system sales database may be narrowed based on predetermined criteria.

In another embodiment, the system may generate the appraisal system sales database by using location mapping. Location Mapping may be used to generate a sales database of comparable sales or real estate properties within a same general neighbourhood of the property of interest. In one embodiment, the appraisal system sales database may include sold real estate properties with designated neighbourhood assignments as part of non-negotiable characteristics. In another embodiment, the system may select real estate properties with comparable sales based on the same municipality and neighbourhood designation as the property of interest or subject property. In another embodiment, the system may populate the appraisal system sales database with real estate properties that have comparable sales based on the proximity to the property of interest using postal codes and/or Geocoding. In another embodiment, Geographic Information System (GIS) software may be used to locate the comparable sales properties.

The information in the appraisal system subject database and/or the appraisal system sales database may then be processed as input values, as outlined below. These input values may be used to assist in the method of real estate appraisal.

After generating the appraisal system subject database and the appraisal system sales database, the system may then merge these databases (206) so that the information in the two databases can be compared. The system may then perform a determination of comparable sales (208) such as via a comparable sales algorithm or module. In other words, the system may then determine which of the real estate properties most closely relate or represent with the property of interest. In one embodiment, the system may execute a comparison methodology or a comparable sales algorithm, to generate a set of, for example five (5), comparable real estate properties with respect to the property of interest. In one embodiment, the system may attempt to find or locate the most recent sales that are closest or most similar (‘high degree of comparability’) to the property of interest.

In one example of a comparison methodology, the system may select the real estate properties that have the most recent sales from the date of the appraisal for comparison with the property of interest or the date that the request for a real estate appraisal is received. In one embodiment, this time period may be three (3) months or less. In another example of a comparison methodology, if comparable properties cannot be found within a predetermined time frame, the system may retrieve or include real estate properties that were sold outside of the time period using, but not limited to, price indexing and an adjustment included for sale date.

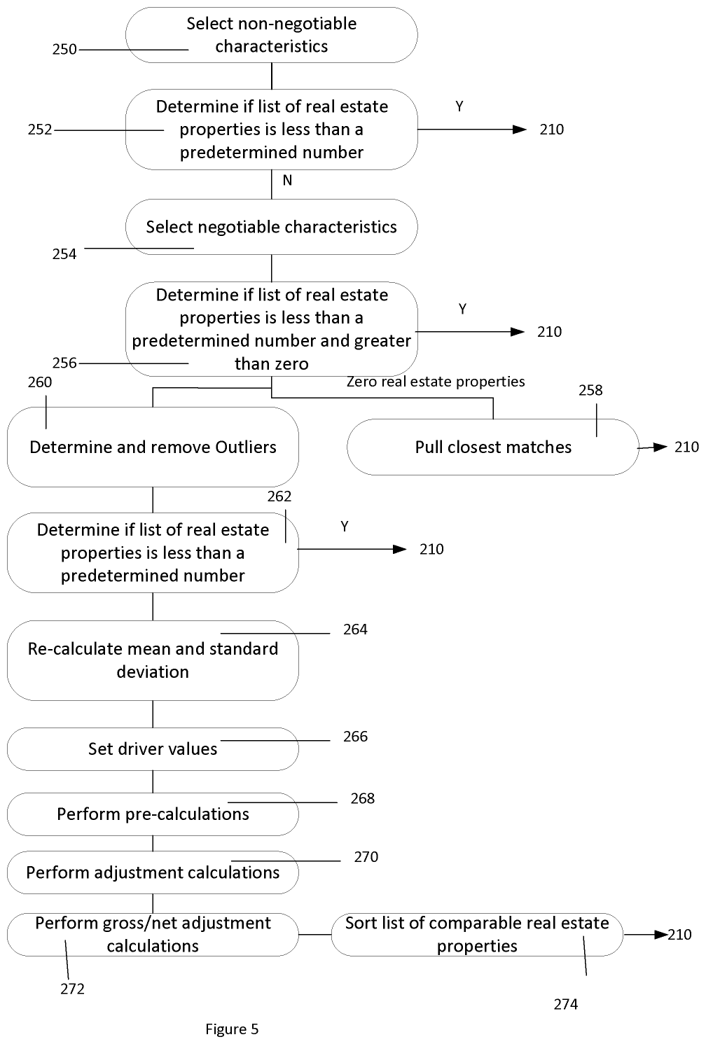

In another example of performing a comparison methodology or determining comparable sales (208) (such as schematically shown in FIG. 5), non-negotiable characteristics or improvements may be selected based on the property of interest (250) for comparison with the list of real estate properties. For example, if the property of interest is a house, sales information associated with apartments or condominiums would not be relevant as a comparable real estate property. A check is then performed to determine if the number of relevant real estate properties (after removing the ones that do not meet or do not match the non-negotiable characteristic of the property of interest) is under a predetermined number (252). If so, the comparable sales output may be generated with these relevant real estate properties (210).

However, if the system determines that there are more comparable real estate properties that the predetermined number, the system may then compare negotiable improvements or characteristics between the property of interest and the remaining real estate properties (254). For example, the system may compare the number of bathrooms and/or the number of parking spots for the property of interest with the same characteristics in the remaining list of real estate properties. If the characteristics of a real estate property does not meet the criteria (or characteristic) of the property of interest, such as for example two (2) bathrooms, the system may then remove the real estate property from the appraisal system sales database. The system may then determine if the list of real estate properties matching the non-negotiable and negotiable characteristics is less than the predetermined number (256). If no real estate properties meet the negotiable characteristics, the system may confirm comparable sales are pulled as close as possible to the property of interest in the event there is no match in the sales database (258). This best fit may be applied to the sales database to pull comparable sales.

If the number of real estate properties are still higher than the predetermined number, the system may then determine or identify any real estate properties that may be categorized as outliers (260). For example, an outlier may be determined where the comparable real estate property has a mean square footage that is outside of one standard deviation from the square footage of the property of interest. These outliers may then be removed from the list of comparable real estate properties. If the predetermined number is met (262), the system generates the comparable sales report (210).

If there are still more comparable real estate properties than the predetermined number, further narrowing of the list of comparable real estate properties is performed. If outliers have been removed, the mean and standard deviation are then recalculated (264). Since the outliers have been removed, an updated determination of standard deviations for the remaining comparable real estate properties is required and then calculated.

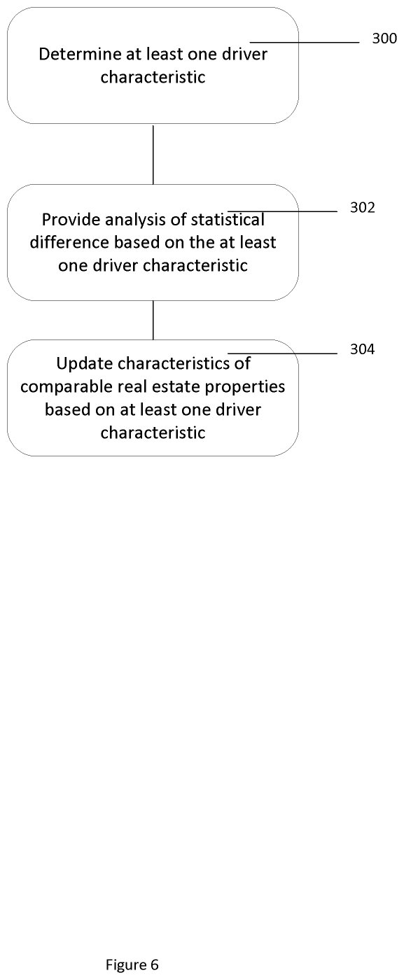

The system may then update the list of comparable real estate properties to reflect criteria such as, but not limited, current sale characteristics. In order to perform this, the system may then set driver values (266). Driver values may be seen as adjustment values where there is a difference between a characteristic of the subject property and a characteristic of a comparable real estate property. For example, if the subject property has a two-car garage and the comparable real estate property has a one-car garage, the price (or sale price) of the comparable real estate property may be adjusted based on the driver value. The setting of the driver values may be performed based on input from the appraiser or based on a paired sales algorithm (such as one schematically shown in FIG. 6). Driver values or characteristics may also be seen as characteristics that should be given consideration with respect to its effect on the final value or its comparability with the property of interest.

As shown in FIG. 6, to generate driver values via a paired sales algorithm, the system may use input from the user to select a single driver adjustment or driver characteristic variable for analysis or may make suggestions based on retrieved information (300). In other words, the real estate appraisal system may use a market analysis approach to determine adjustment (driver) values or characteristics. In one embodiment, to assist the user in making local market decisions regarding driver characteristics or adjustments that affect the valuation of the subject property, isolated characteristics or factors or the comparable real estate properties can be measured and given values to assist the user with up to date and accurate adjustment/driver data.

More specifically, in one example, the user may select or input at least one driver characteristic that requires consideration which is the received by the system. The at least one driver characteristic may include, but is not limited to, time, location, square footage, bedrooms, bathrooms, parking, basement finish, market rents, land sales and green space. The user chooses a particular driver characteristic and the system then isolates the selected at least one driver characteristic and locates all comparable real estate properties in the remaining list that have matched all the other non-negotiable and negotiable characteristics and provides an analysis of the statistical difference pertaining to that at least one driver characteristic (302). For example, if the user wants to know whether ‘location’ of a subject property needs adjustments, the system may find comparable real estate properties that have identical characteristics with respect to square footage, parking, bathrooms as the subject property and determines if there is a difference in sale price due to the different location between the subject property and the comparable real estate properties. The system may then calculate these values (or update the sale prices of the comparable real estate properties) which can include, but not limited to, dollar amounts, percentages or time factors as adjustment/driver data (304).

The method of FIG. 6 may be seen as a paired sales analysis that find matches between the comparable real estate properties while holding non-driver characteristics constant. For example, if square footage is used as the driver characteristic, in order to determine a square footage adjustment or driver value, the remaining list of comparable real estate properties are sorted with respect to square footage and then the comparable real estate properties having square footages closest to one another form a pair. In this example, the non-negotiable characteristics may include municipality property_type; building_type and/or design_style and the negotiable characteristics may include square footage, bedrooms, full bath, half bath, basement, and parking for negotiable characteristics. The system may also provide the user with real-time data regarding driver adjustments which could include, but are not limited to, date of sale, location, square footage, basement finish, parking and externalities such as green space, hydro wires or condominium floor level.

Once pairs are established, the negotiable characteristics excluding square footage are held constant and pairs are identified in terms of price and square footage and then saved in a database. The average price and average square footage for each of the pairs is then calculated using different levels of detail for the non-negotiables characteristics to narrow down the list of comparable real estate properties. For instance, a highest level of detail may require that for each pair, the non-negotiable characteristics all match. If no pairs fit this criteria, the system may then determine if any of the pairs have three of the four non-negotiable characteristics in common. If no pairs fit this updated criteria, the system may then determine if any of the pairs have two of the four characteristics in common. If no pairs fit this updated criteria, the system may then determine if any of the pairs have one non-negotiable characteristic in common. One example is listed below. It is understood that in this example, the non-negotiable characteristic of municipality has been selected as the non-negotiable for matching in each of the levels, however, it is understood that this may be varied and is based on decisions by the appraiser.
Level 4: municipality property_type building_type design_style
Level 3: municipality property_type building_type
Level 2: municipality property_type
Level 1: municipality

In this embodiment, the system may be able to assign a driver at a higher level of detail if one is not available at a lower level of detail. For example, if there is no driver available at level 4 because no pairs were identified in the list or remaining comparable real estate properties, but there is a matched pair, or driver, available at level 3, level 3 is assigned as the driver. The process may then be repeated for each negotiable that has been selected as a driver characteristics.

In another specific example of determining driver characteristics, the system may access or process the set of comparable real estate properties. The floor area of each of the real estate properties may then be rounded to the nearest 5 feet and lot size may be rounded to the nearest 5 feet. The set of comparable real estate properties are then stored by non-negotiable and negotiable characteristics. Pairs of comparable real estate properties with the same non-negotiable characteristics with the same number of bathrooms, same basement (finished/unfinished), and same number of parking spaces are then determined. Drivers are then calculated for every pair in the group by calculating the difference in price divided by the difference in floor area or lot area. Every property in the group is compared to every other. For example, if there are 8 real estate properties in the group, property 1 is compared to 2, then 3, . . . , then 8. Property 2 is compared to 3, 4, . . . , 8 and so on. The drivers are then averaged. For example, if there were 8 pairs, there would be driver1's calculated by comparing property 1 to all of the others, driver2's calculated by comparing property 2 to properties 3 through 8, and so on. The driver 1's are averaged, the driver 2's are averaged, and so on. The drivers are then averaged again for each group where the non-negotiable characteristics are the same and bathrooms, basement, parking and condition are the same. The drivers are then averaged again to give a driver for the entire dataset. In one embodiment, prior to calculating lot area, the floor area driver may be multiplied by floor area for each sold property. The values are then subtracted from the sold price. For example, if the floor area driver was 158, and the floor area was 2,000, and the sold price was 750,000, the revised sold price becomes 434,000 (750,000−158×2000). The lot area driver indicates a possible land valuation for the entire lot.

In another example of determining driver characteristics, a paired sales methodology may be used, such as by bathrooms, basement, parking, and condition. In this embodiment, the paired sales analysis may be used to calculated the following four drivers: dollars per bathroom, dollars per basement, dollars per parking, and dollars per condition. The appraiser may use these values when adjusting the value of the subject property by applying these values to the comparables to account for differences between the subject property and the comparables.

The non-negotiable characteristics include municipality, property_type, building_type, and design_style. The negotiable characteristics that are kept the same in this paired sales analysis are bathrooms (full bath and half bath), basement, parking, and condition.

Initially, in this specific example of determining driver characteristics, the system may access or process the set of comparable real estate properties. Pairs of real estate properties may then be sorted holding non-negotiable characteristics constant except for one of bathrooms, basement, parking, and condition. The other three remain constant. For example, if property A has one more bathroom than property B, and everything else is the same, this constitutes one pair within a group. Drivers are then calculated for every pair in the group by calculating the difference in price divided the difference in bathrooms or basement or parking. Every property in the group is compared to every other. For example, if there are 8 properties in the group, property 1 is com-pared to 2, then 3, . . . , then 8. Property 2 is compared to 3, 4, . . . , 8 and so on. The drivers are then averaged. For example, if there were 8 pairs, there would be driver1's calculated by comparing property 1 to all of the others, driver2's calculated by com-paring property 2 to properties 3 through 8, and so on. The driver 1's are averaged, the driver 2's are averaged, and so on. These drivers are then averaged again for each group where the non-negotiables are the same and three of bathrooms, basement, parking, and condition are the same. After averaging, these updated driver values are then averaged again to give a driver for the entire dataset. The user may then verifies the driver value using local appraisal knowledge.

Once the characteristics (or, more specifically, the price/value characteristic of the comparable real estate properties) has been updated, pre-calculations may then be performed by the system to further facilitate a comparison between the property of interest and the comparable real estate properties (268). In one embodiment, this may be performed by the adjustment/reconciliation module 110i whereby the user selected comparable real estate properties in the list of comparable real estate properties are read by the adjustment/reconciliation module.

The comparable real estate properties may then be compared to the appraisal's system subject database or the subject property. Adjustments may be automatically applied by the system, according to pre-entered adjustment data and parameters that are set by the user according to local market conditions (270). For example, adjustments may be made based on a frontage or lot area adjustment of $50/ft. This results in adjusted valuations of the comparable sale properties that provide the basis for valuation of the property of interest. The system may also calculate or generate gross/net adjustment calculations (272).

In one specific example, the system sorts the adjusted valuations of the comparable real estate properties. In one embodiment, this may be performed according to either gross or net adjustment values. Lower gross or net values for a comparable real estate property may reflect a closer valuation (or, a higher degree of similarity) to the property or interest. Weighting factors may be determined by the variance of gross or net adjustments of each comparable real estate property. The closer the gross or net adjustments are to 0, the more weight that is given to that specific adjusted valuation of the comparable real estate property.

In one embodiment, the list of comparable real estate properties may be sorted in ascending order, by gross or net percent difference. The comparable sales report can then be generated using a pre-selected number of comparables, such as, but not limited to, five (5).

Turning back to FIG. 4, the comparable sales report can then be displayed to a user (212) who can use the comparable sales report to assess and evaluate the list of comparable sales. The system may also assign an overall condition score to each of the real estate properties within the comparable sales report, using photographs from the database.

Turning back to FIG. 3, from the generated comparable sales output, the user or appraiser may then select a number of real estate properties and then input them into the system which is then received by the system (160). This may be accomplished by the user assessing the list of comparable real estate properties from the comparable sales report or output. For example, if the top three comparable real estate properties generated by the algorithm (or in the list or comparable sales report) are all the same condition as the property of interest, those will be displayed.

In another mode of operation, the user may request another five, or more real estate properties if the initial 5 do not meet the user standard for comparable properties. These other comparable real estate properties may be retrieved from the original list of comparable real estate properties that may have been removed from the list for not matching one or some of the non-negotiable or negotiable characteristics.

Another mode of operation would include the user requesting sales properties by ascending or descending sold prices (after non-negotiable analytics) which can also reflect, but is not limited to, condition of comparable properties.

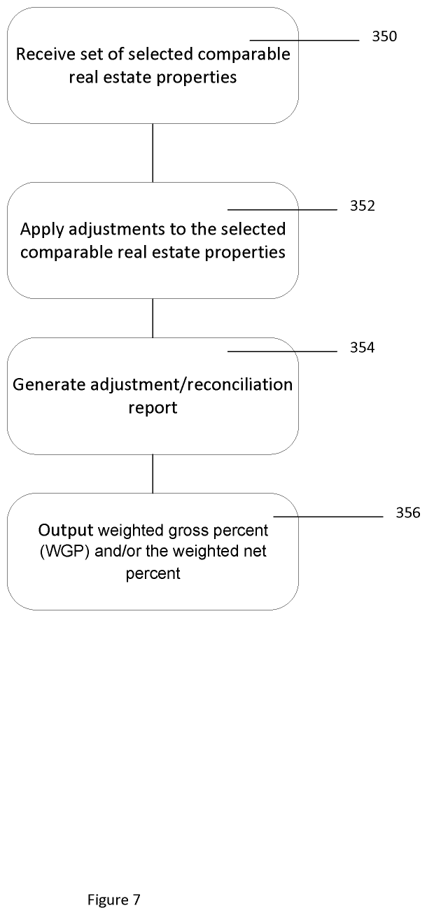

The system may then select a predetermined number (such as 3) real estate properties (based on the appraiser's input) and then generates an Adjustment/Reconciliation report based on the received real estate properties (162). The selected comparable real estate properties, with their data, may then be read by an Adjustment/Reconciliation Algorithm or module. A schematic diagram of a method of adjustment/reconciliation is shown in FIG. 7. Depending if adjustments to the sale prices/values of the comparable real estate properties previously, adjustment/reconciliation of this characteristic may be performed by the system. For instance, if the list has been generated after comparing non-negotiable or negotiables in FIG. 5, updates to the adjustments may be required.

Turning to FIG. 7, the system receives the selected comparable real estate properties (350). The system may then apply adjustments to the valuations of the selected comparable real estate properties (352). These adjustments may be as discussed above, if they weren't performed previously. The updated comparable real estate properties may then be reported to the appraisal valuation (354). The output weighted gross percent (WGP) and/or the weighted net percent (WNP) may then be output and/or displayed (356). All comparable sales may then be sorted, and further user specific adjustments and refinements performed, before the adjustment/reconciliation report is sent to the appraisal report (274).

A final valuation (or real estate appraisal) of the property of interest is then calculated, generated or reconciled. The appraiser then verifies, assesses and approves the final valuation. All data, adjustments and valuations may then be auto-populated into a final report which parallels with expected standards (162).

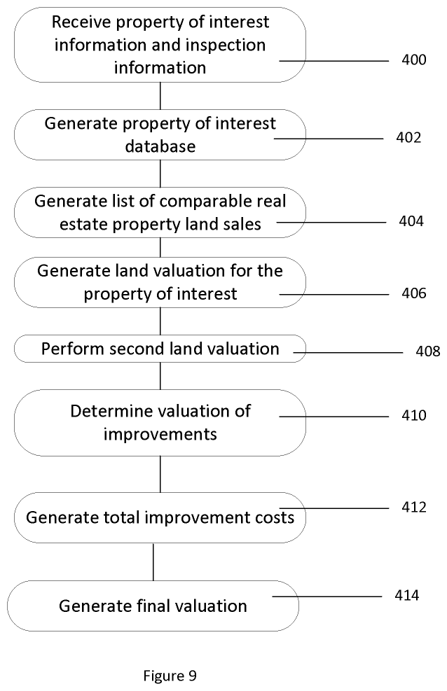

In another embodiment of real estate appraisal, the appraisal may be performed based on a cost approach. An embodiment of this method is schematically shown in FIG. 9. The cost approach to valuation of a subject property is premised on the cost of acquiring land and building a new or substitute property to replace (or replicate) the subject improvements. The cost valuation must be adjusted for depreciation of the existing property of interest. In one embodiment, the system includes an auto-assisted valuation model using a cost approach to valuation.

Initially, the system receives subject property information along with inspection information associated with the subject property or property of interest (400). This information may be received directly from user input or retrieved from external sources. A subject property or property of interest database or entry can then be generated (402). A list of comparable land sales may then be generated (404) that may be displayed to the user. It will be understood that the system may perform a comparison between the characteristics (negotiable and non-negotiable) of the property of interest and the comparable real estate properties before the list of comparable land sales is generated in order to obtain comparable real estate properties that relate to the property of interest.

The list of comparable land sales may then be assessed and finalized using appraiser expertise or input or may be automated based on pre-determined characteristics. Adjustments are then made via pre-entered adjustment data and parameters that are set by the user according to local market conditions. A valuation for land is then generated using a comparable land sales algorithm (or module) (406). If a further land valuation is desired, the system may perform a second land valuation using an extraction algorithm or methodology (408). In one embodiment of an extraction methodology, the land valuation is determined by subtracting the cost of improvements (such as those listed below) from the sold price of the comparable real estate properties. A valuation per square foot of land may be determined based on, but not limited to, a neighbourhood or location mapping area. This value may then be applied to the subject property land total square footage.

Next, a valuation of improvements (replacement cost, or in another mode of operation, reproduction cost) to the property of interest and/or the comparable real estate properties is determined (410) using local market conditions input by the user. This may include, but is not limited to, information received via discussions with local home builders or accessing construction cost data retrieved from external sources. In one embodiment, the system receives inputs from the user relating to improvements regarding a subject property which includes, but is not limited to, total above grade square footage, total basement square footage, condition of property, garages, landscaping or home improvements. During inspection of the property, the user may estimate the accrued depreciation of the improvements using their appraisal experience and knowledge and input them into the system. Total improvement costs are then generated using a subject improvements replacement cost algorithm (or module) (412). The system may then combine the land valuation or land valuations and replacement cost of improvements and the determined depreciation to generate a final valuation of the subject property is generated (414). This final valuation may be verified by the user. All data, adjustments and valuations may then be auto-populated into a final report which parallels with expected standards.

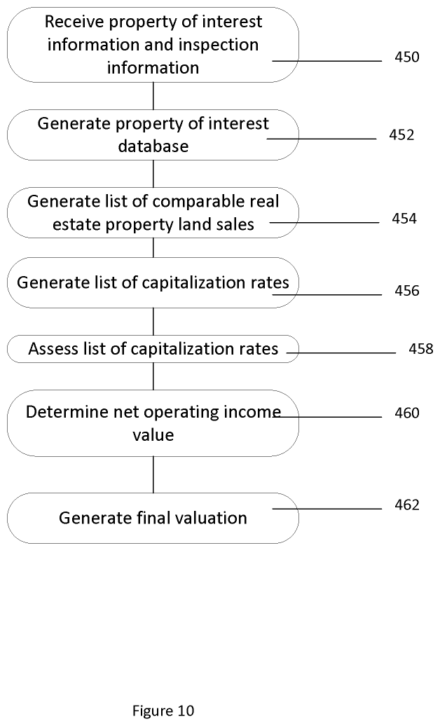

In another embodiment of valuation, the valuation of a property of interest may be performed using an income approach. An embodiment is schematically shown in FIG. 10. The income approach to valuation may be seen as a methodology that analyzes a subject property's ability to generate income for future benefits. This enables the capitalization of the income that establishes a present value.

In this embodiment, there is provided a real estate appraisal system using an auto-assisted valuation model using an income approach to valuation. By accessing live data on real estate sales and market rents, capitalization rates can be generated by the system using an algorithm (or module). Initially, the system receives subject property information along with inspection information associated with the subject property or property of interest (450). This information may be received directly from user input or retrieved from external sources. A subject property or property of interest database or entry can then be generated (452). The system may then retrieve all of the comparable real estate properties (454) for comparison with the property of interest such as disclosed above. A set of capitalization rates based on the subject property and the comparable real estate properties, such as for the local market, is then generated (456). The capitalization rates may then be displayed to the user for assessment or may be assessed by the system based on previous inputted user expertise or may be automated based on pre-determined characteristics (458). A projected net operating income value may then be determined (460) based on market rent data of comparable properties to the subject property. A subject property valuation is generated (462) by using local, finalized capitalization rates as a ratio to net operating income. This final valuation may be verified by the user. All data, adjustments and valuations may then be auto-populated into a final report which parallels with expected standards.

In another embodiment, the valuation of a property of interest may be performed using a regression analysis. The regression analysis approach to valuation may be seen as a methodology that analyzes subject property data using a statistical relationship of comparable sales data to determine variables that contribute to valuation.

The regression is continually updated as new data is entered into the database. In one embodiment of regression, the regression analytics or module for determining regression analytics provides a property valuation using an additive model for, but not limited to, the following example:

For a 2 storey, detached property the valuation may be determined by:

Valuation=Constant+(square footage×sqft variable)+(frontage×front variable)+(# of full baths×bath variable)+(parking×park variable)

The regression analysis determines the valuation amount for each variable in the equation. The ‘constant’ is also determined by the regression modelling. Although this value attempts to explain all of the other variables that contribute to total valuation, this ‘unknown’ is the main reason why residential real estate appraisers are reluctant to use regression analysis. The system of the disclosure provides solutions for these gaps in valuation, using the regression analytics as a way to provide another verification of subject property valuation.

All input and output data obtained throughout the process may then be automatically populated into a final report which parallels with expected standards. This final report may then be transmitted to the user or appraiser.

In a further embodiment of real estate appraisal, or a method to determine a valuation of a subject property, an analysis of the methodologies disclosed above (the comparison, cost, income and regression methodologies) may be performed.

The valuations by the system using the comparison approach, cost approach, income approach and regression analysis are retrieved (500). Based on user input, weighting factors for the different approaches/analysis are determined (502). These weighting factors may different for each real estate appraisal due to different parameters such as local conditions, real estate market and the like. For example, but not limited to, if the purpose of the appraisal is to determine market value, the comparison approach methodology will be given a higher, or possibly all, weighted valuation. A final, reconciled valuation is then calculated (504) which may be verified and approved by the appraiser for the final report.

In another specific embodiment of the system, there is provided a real estate appraisal system using an auto-assisted valuation model. By accessing live data on real estate sales, comparable sales can be generated by the system using an algorithm (or module) working with inputs from an appraiser or user. The system may use a mobile application for inspections of subject properties which provides input data to the system of the disclosure. Real estate sales may be automatically updated through data mining software to create a database for the system. In one example, the user enters the subject property (address, client, contact information, etc) into the application. The user then inspects the subject property and enters information about the subject property (municipality, map location, property type, building type, design style, bedrooms, full bath, half bath, basement, parking) from the definitions above which creates the subject property database. A database of comparable real estate properties is also generated based on information or input from external information sources. The databases or databases may be merged and an algorithm or module to generate a list of comparable real estate properties. The list of comparable real estate properties may be generated based on a comparison of non-negotiable and negotiable characteristics between the subject property and the database of comparable real estate properties.

In a specific example of the disclosure, the system determines or finds five (5) comparable real estate properties with respect to the property of interest. In this example, the system compares characteristics of the property of interest with characteristics of other real estate properties to generate a list of five comparable real estate properties to providing an appraisal of the property of interest based on selected characteristics. For example, characteristics may include, but are not limited to, municipality (region where the property of interest is located), map location, property_type, building_type (the type of building i.e. condominium, detached, bungalow), design_style (the style of the property i.e. bungalow, 2 storey), bedrooms (the number of bedrooms), full_bath (the number of full bathrooms), half bath (the number of half-bathrooms), basement (finished or unfinished), and parking (number of parking spots). In some embodiments, the characteristics may include a set of non-negotiable characteristics and a set of negotiable characteristics. For example, one non-negotiable characteristics that needs to be compared is municipality as it would not make sense to generate a real estate appraisal based on values of real estate in a different city or town, or even a different neighborhood within the same city or town. The non-negotiable characteristics assist to generate a list of comparable real estate properties that more closely match the property of interest.

The system may then determine a square footage variance (calculated in an absolute value) based on the non-negotiable characteristics. After, in order to determine the sales of real estate properties that best compare with the property of interest, the system determines a number of “negotiable characteristics” in each category. In one embodiment, the negotiable characteristics may be ranked in terms of priority (bedrooms #1, full bath #2, half bath #3, basement #4, parking #5). The system goes sequentially through the negotiables from highest priority (#1) to lowest priority (#5) and will stop at the end of an iteration if 5 or fewer records (or real estate properties) are found or it reaches the last iteration.

The system may also process the list of comparable real estate properties to determine or identify if there are any outliers within the list. For example, an outlier may be determine as a real estate property where the square footage of the property of interest is outside of 1 standard deviation from the mean square footage of the real estate properties in the list. This ensures the smallest deviation between the list of real estate properties and the property of interest, ensuring lower adjustments for square footage. In one embodiment, if there are more than 5 real estate properties in the list, the system may remove outliers ensuring there aren't fewer than 5 real estate properties in the list after the outliers are removed. The system may then recalculate the mean and standard deviation based on square footage with the updated list of real estate properties.

Driver values may then be set. These may be user-generated from local market conditions or, in another mode of operation, using the paired sales analysis algorithm.

The list is then displayed to the user (or appraiser) who may then select any number of real estate properties, such as three, to generate an appraisal for the property of interest. The method and system of the disclosure then calculates a gross value for the property of interest and net adjustments followed by a valuation of the property of interest which may be weighted based on how close the gross and net adjustments are to zero in absolute value. This results in a final, reconciled valuation of the property or interest or a real estate appraisal.

Sample calculations for this specific may be seen as below using variable names that may be changed but for the current specification are used to assist in understanding the calculations:

### Example Drivers

driver_frontage=1000.
driver_condition=25.
driver_floor_area=150.
driver_bathroom=5000.
driver_basement=5000.
driver_parking=10000.

Pre-Calculations:
bathroom_count=(full_bath+half_bath/2).
subject_bathroom_count=(subject_full_bath+subject_half_bath/2).
square_footage_from_subject=(subject_square_footage−square_footage).

Calculations:
adj_frontage=((subject_frontage−frontage)*driver_frontage).
adj_condition=(((!subject_condition−condition)*square_footage_from_subject)*driver_condition).
adj_floor_area=(square_footage_from_subject*driver_floor_area).
adj_bathroom=((subject_bathroom_count−bathroom_count)*driver_bathroom).
adj_basement=((subject_basement−basement)*driver_basement).
adj_parking=((subject_parking−parking)*driver_parking).

Gross/Net Adjustments:
adj_gross=(ABS(adj_frontage)+ABS(adj_condition)+ABS(adj_floor_area)+ABS(adj_bathroom)+ABS(adj_basement)+ABS(adj_parking)).
adj_net=(adj_frontage+adj_condition+adj_floor_area+adj_bathroom+adj_basement+adj_parking).
pct_gross=((adj_gross/price)*100).
pct_net=((adj_net/price)*100).
price_adj=price+adj_net.

The comparables may then be sorted in ascending order by pct_gross form. It is possible that there may not be any actual sold and only pending sold as comparables depending on the size of the sales database. Assign a rank to each one (e.g. 1, 2, 3, 4, . . . , n), with the lowest ranking comparable property having the highest degree of comparability to the subject property thus far in the process. The system reports the top 5 comparables to the user for review

The list of comparable real estate properties may then be assessed and finalized using appraiser expertise or may be automated based on pre-determined characteristics. In one embodiment, the appraiser may select the three comparable properties based on analyzing images and assigning an overall condition to each of the real estate properties that best compare to the property of interest.

Alternatively, adjustments may be made via pre-entered adjustment data and parameters that are set by the appraiser according to local market conditions. Using a weighted net and gross adjustment algorithm, a final, objective adjustment/reconciliation of the subject property valuation is generated and verified by the appraiser. In one embodiment, the comparables may be weighted by the pct_gross value that is calculated. The weights or weighting factors are then imputed such that the lower the pct_gross the higher the weighting factor whereby the weighting factors add up to 100 percent. The subject price share is equal to the price of the comparable multiplied by the weight. If the weight is zero, the subject price share may be set equal to the adjusted price (price_adj).

All data, adjustments and valuations are auto-populated into a final report which parallels with expected standard.

While not platform specific, the current disclosure may find benefit in being implemented within a blockchain/hyper ledger/smart contract environment.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein) or within blockchain technology. The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method of generating a real estate appraisal comprising:
generating a property of interest entry, the property of interest entry include a set of property of interest non-negotiable characteristics and a set of property of interest negotiable characteristics;
generating a list of comparable real estate properties, each of the list of comparable real estate properties including a set of real estate property non-negotiable characteristics and a set of real estate property non-negotiable characteristics;
generating a comparable sales report of relevant real estate properties based on a comparison between the set of property of interest non-negotiable characteristics and the set of real estate property non-negotiable characteristics for each of the list of comparable real estate properties; and
generating a final valuation for the property of interest based on a selection of relevant real estate properties.

2. The method of claim 1 wherein the generating a comparable sales report is also based on a comparison between the set of property of interest negotiable characteristics and the set of real estate property negotiable characteristics for each of the list of comparable real estate properties.

3. The method of claim 1 wherein generating a final valuation comprises:
performing an adjustment/reconciliation on sales values of the selected relevant real estate properties; and
calculating the final valuation based on the adjustment/reconciliation on the sales values.

4. The method of claim 3 wherein performing an adjustment/reconciliation on sales values comprises:
determining a set of driver values; and
applying adjustments to the sales values based on the driver values.

5. The method of claim 4 wherein determining a set of driver values is via a paired sales methodology.

6. The method of claim 1 wherein generating a final valuation for the property of interest based on a selection of relevant real estate properties comprises:
obtaining a comparable methodology property of interest valuation;
obtaining a cost methodology property of interest valuation;
obtaining an income methodology property of interest valuation;
obtaining a regression methodology property of interest valuation;
calculating the final valuation by weight factoring and adding the comparable methodology property of interest valuation, the cost methodology property of interest valuation, the income methodology property of interest valuation, and the regression methodology property of interest valuation.

7. The method of claim 1 wherein the adjustments include gross/net adjustments.

8. The method of claim 7 wherein the gross/net adjustments comprise weighted gross percent adjustments and weighted net percent adjustments.

9. A computer-implemented method for generating a real estate appraisal comprising:
under the control of one or more computer system configured with executable instructions,
generating a property of interest entry, the property of interest entry include a set of property of interest non-negotiable characteristics and a set of property of interest negotiable characteristics;
generating a list of comparable real estate properties, each of the list of comparable real estate properties including a set of real estate property non-negotiable characteristics and a set of real estate property non-negotiable characteristics;
generating a comparable sales report of relevant real estate properties based on a comparison between the set of property of interest non-negotiable characteristics and the set of real estate property non-negotiable characteristics for each of the list of comparable real estate properties; and
generating a final valuation for the property of interest based on a selection of relevant real estate properties.

10. A system for generating a real estate appraisal, the system comprising:
a processing system for receiving a real estate appraisal request and for providing the real estate appraisal, the processing system including:
a comparator module for comparing characteristics between property of interest and a list of comparable real estate properties and for generating a comparable sales report;
an adjustment/reconciliation module for applying adjustments to sales values of selected real estate properties within the comparable sales report; and
a valuation module for generating a final valuation for the real estate appraisal based on adjusted sales values of the selected real estate properties.

11. The system of claim 10 further comprising:
a database module for translating information received from external sources for use by the system.
